(19) United States
(12) Patent Application Publication
(10) Pub. No.: US 2025/0070850 A1
(43) Pub. Date: Feb. 27, 2025

(54) METHOD AND APPARATUS FOR DISCONTINUOUS TRANSMISSION AND RECEPTION OF WIRELESS COMMUNICATION SYSTEM

(71) Applicant: SAMSUNG ELECTRONICS CO., LTD., Suwon-si (KR)

(72) Inventors: Youngbum KIM, Suwon-si (KR); Hyunsuk RYU, Suwon-si (KR); Junyung YI, Suwon-si (KR)

(21) Appl. No.: 18/812,689

(22) Filed: Aug. 22, 2024

(30) Foreign Application Priority Data
Aug. 24, 2023 (KR) 10-2023-0111547

(51) Int. Cl. H04B 7/06; H04W 52/02; H04W 76/28

(52) U.S. Cl. CPC H04B 7/06968; H04W 52/0235; H04W 76/28

(57) ABSTRACT

The disclosure relates to a 5G or 6G communication system for supporting a higher data transmission rate. The disclosure may provide a method and an apparatus for saving power of a wireless communication system. According to the disclosure, a method performed by a terminal in a communication system is provided. The method includes: receiving, from a base station, configuration information on a network energy saving mode; identifying that the network energy saving mode is applied; identifying an uplink transmission power for transmitting an uplink signal on an uplink channel in the network energy saving mode or a quasi co-location (QCL) relation of at least one of downlink signal or a downlink channel based on a reference signal in the network energy saving mode; and transmitting, to the base station, the uplink signal on the uplink channel based on the uplink transmission power or receiving, from the base station, the downlink signal on a downlink channel based on the QCL relation.

### CROSS-REFERENCE TO RELATED APPLICATION

This application is based on and claims priority under 35 U.S.C. § 119 to Korean Patent Application No. 10-2023-0111547, filed on Aug. 24, 2023, in the Korean Intellectual Property Office, the disclosure of which is herein incorporated by reference in its entirety.

### BACKGROUND

### 1. Field

The disclosure relates to a communication method of a wireless communication system and, more particularly, to a method and an apparatus for energy saving in a wireless communication system.

### 2. Description of Related Art

5^{th} generation (5G) mobile communication technologies define broad frequency bands to provide higher transmission rates and new services, and can be implemented in “Sub 6 GHz” bands such as 3.5 GHz, and also in “above 6 GHz” bands, which may be referred to as mm Wave bands including 28 GHz and 39 GHz. In addition, the implementation of 6^{th} generation 6G mobile communication technologies (e.g., beyond 5G systems) in terahertz bands (e.g., 95 GHz to 3 THz bands) has been proposed in order to achieve transmission rates fifty times faster than 5G mobile communication technologies and ultra-low latencies one-tenth of 5G mobile communication technologies.

Since the beginning of the development of 5G mobile communication technologies, in order to support various services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings (SCSs)) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio (NR)-Unlicensed (U) aimed at system operations conforming to various regulation-related requirements in unlicensed bands, NR UE power saving, non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also full-duplex technologies for increasing frequency efficiency of 6G mobile communication technologies and improving system networks, AI-based communication technologies for implementing system optimization by utilizing satellites and AI from the design stage and internalizing end-to-end AI support functions, and next-generation distributed computing technologies for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to provide methods and devices for energy saving in a wireless communication system.

The above information is presented as background information only to assist with an understanding of the disclosure. No determination has been made, and no assertion is made, as to whether any of the above might be applicable as prior art with regard to the disclosure.

### SUMMARY

A disclosed embodiment may provide an apparatus and a method capable of effectively providing a service in a wireless communication system. Particularly, a method and an apparatus for energy saving in a wireless communication system may be provided.

In order to solve the above-mentioned problems, in accordance with an aspect of the disclosure, a method performed by terminal in a communication system is provided. The method includes receiving, from a base station, configuration information on a network energy saving mode; identifying that the network energy saving mode is applied; identifying an uplink transmission power for transmitting an uplink channel in the network energy saving mode or a quasi co-location (QCL) relation of at least one of downlink signal or a downlink channel based on a reference signal in the network energy saving mode; and transmitting, to the base station, the uplink channel based on the uplink transmission power or receiving, from the base station, the at least one of downlink signal or a downlink channel based on the QCL relation.

In accordance with another aspect of the disclosure, a method performed by a base station in a communication system is provided. The method includes transmitting, to a terminal, configuration information on a network energy saving mode; identifying that the network energy saving mode is applied; and receiving, from the terminal, an uplink channel or transmitting, to the terminal, at least one of downlink signal or a downlink channel using a quasi co-location (QCL) relation based on a reference signal in the network energy saving mode, wherein an uplink transmission power for the uplink channel corresponds to the uplink transmission power for in the network energy saving mode.

In accordance with another aspect of the disclosure, a terminal in a communication system is provided. The UE includes transceivers; and a controller configured to: receive, from a base station, configuration information on a network energy saving mode, identify that the network energy saving mode is applied, identify an uplink transmission power for transmitting an uplink channel in the network energy saving mode or a quasi co-location (QCL) relation of at least one of downlink signal or a downlink channel based on a reference signal in the network energy saving mode, and transmit, to the base station, the uplink channel based on the uplink transmission power or receive, from the base station, the at least one of downlink signal or a downlink channel based on the QCL relation.

In accordance with another aspect of the disclosure, a base station in a communication system is provided. The base station includes transceivers; and a controller configured to: transmit, to a terminal, configuration information on a network energy saving mode, identify that the network energy saving mode is applied, and receive, from the terminal, an uplink channel or transmit, to the terminal, at least one of downlink signal or a downlink channel using a quasi co-location (QCL) relation based on a reference signal in the network energy saving mode, wherein an uplink transmission power for the uplink channel corresponds to the uplink transmission power for in the network energy saving mode.

A disclosed embodiment provides an apparatus and a method for preventing excessive energy consumption in a wireless communication system, and accomplishing a high level of energy efficiency.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency resource domain of a 5G system according to an embodiment of the disclosure;

FIG. 2 illustrates a beam sweeping operation and a time domain mapping structure of a synchronization signal according to an embodiment of the disclosure;

FIG. 3 illustrates a random access procedure according to an embodiment of the disclosure;

FIG. 4 illustrates a procedure in which a UT reports UE capability information to a gNB according to an embodiment of the disclosure;

FIG. 5 illustrates an example of a cell DTX operation according to an embodiment of the disclosure;

FIG. 6 illustrates an example of a method of a UE for measuring pathloss according to an embodiment of the disclosure;

FIG. 7 illustrates a UE procedure according to an embodiment of the disclosure;

FIG. 8 illustrates a gNB procedure according to an embodiment of the disclosure;

FIG. 9 illustrates a transmission/reception device of a UE according to an embodiment of the disclosure;

FIG. 10 illustrates a structure of a UE according to an embodiment of the disclosure; and

FIG. 11 illustrates a structure of a base station according to an embodiment of the disclosure.

### DETAILED DESCRIPTION

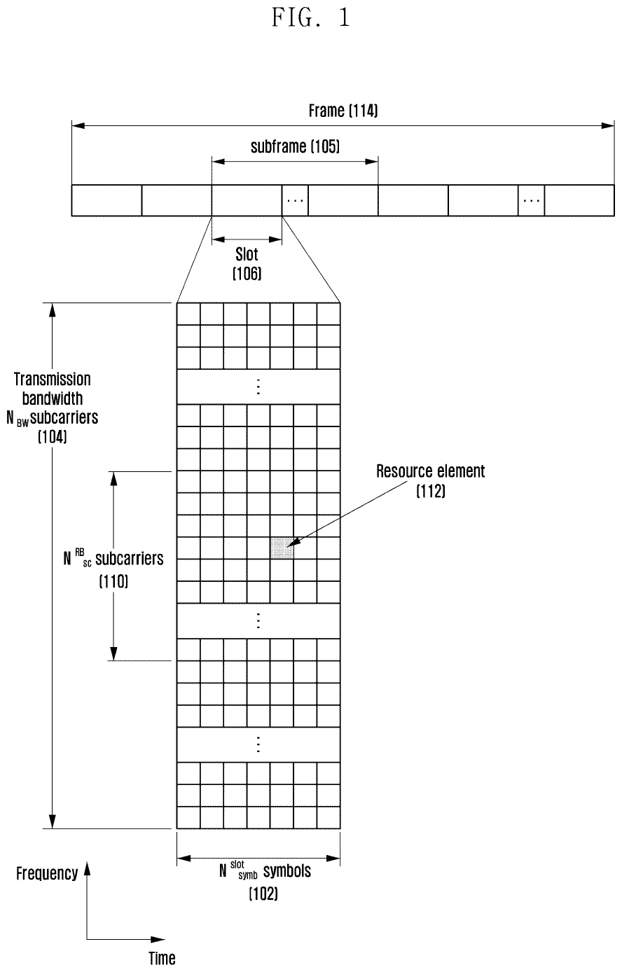

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal.” For example, the term “physical downlink shared channel (PDSCH)” refers to a physical channel over which data is transmitted, but the PDSCH may also be used to refer to the “data.” That is, in the disclosure, the expression “transmitting a physical channel” may be construed as having the same meaning as the expression “transmitting data or a signal over a physical channel.”

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description, terms and names defined in the 3GPP new radio standards (3GPP NR: 5th generation mobile communication standards) are used for the sake of descriptive convenience. However, the disclosure is not limited by these terms and names, and may be applied in the same way to systems that conform other standards.

In the following description, a base station is an entity that allocates resources to terminals, and may be at least one of a gNode B, a gNB, an eNode B, an eNB, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In the following, “A/B” may be understood as A and/or B or at least one of A or B.

In order to process mobile data traffic which has recently increased exponentially, initial standards of new radio (NR) access technology or 5^{th} generation (5G) systems which are next-generation communication systems after long term evolution (LTE) (or evolved universal terrestrial radio access (E-UTRA)) and LTE-advanced (LTE-A) (or E-UTRA evolution) have been completed. While legacy mobile communication systems have focused on conventional voice/data communication, 5G systems aim to satisfy various services and requirements, such as an enhanced mobile broadband (eMBB) service for improving legacy voice/data communication, an ultra-reliable and low latency communication (URLLC) service, and a massive machine type communication (MTC) service supporting massive machine-to-machine communication.

The system transmission bandwidth per single carrier of legacy LTE and LTE-A is limited to a maximum of 20 MHz, but 5G systems aim to provide super-fast data services up to multiple Gbps by using super-broad bandwidths far wider than the same. Accordingly, 5G systems consider super-high-frequency bands ranging from multiple GHz to a maximum of 100 GHz, in which it is relatively easy to secure super-broad-bandwidth frequencies, as candidate frequencies. Additionally, it is possible to secure broad-bandwidth frequencies for 5G systems through frequency rearrangement or allocation among frequency bands ranging from hundreds of MHz to multiple GHz used in legacy mobile communication systems.

Radio waves in super-high frequency bands have millimeter-level wavelengths and thus are also referred to as millimeter waves (mm Wave). However, the pathloss of radio waves in super-high frequency bands increases in proportion to the frequency band, thereby reducing the coverage of the mobile communication systems.

In order to overcome the shortcoming of coverage reduction in super-high frequency bands, a beamforming technology is applied such that the distance reached by radio waves is increased by concentrating the energy radiated by the radio waves at a specific target point by using multiple antennas. That is, signals to which the beamforming technology is applied have a smaller beam width, and radiated energy is concentrated within the smaller beam width, thereby increasing the distance reached by radio waves. The beamforming technology may be applied to each of the transmission and reception ends. In addition to the increased coverage, the beamforming technology is also advantageous in that interference is reduced in regions in directions other than the beamforming direction. Appropriate operations of the beamforming technology require a method for accurately measuring transmitted/received beams and sending feedback. The beamforming technology may be applied to a control channel or a data channel having one-to-one correspondence between a UE and a gNB. In addition, the beamforming technology may also be applied to a control channel and a data channel for transmitting a common signal transmitted from a gNB to multiple UEs in the system, such as a synchronization signal, a physical broadcast channel (PBCH), and system information, in order to increase the coverage. When the beamforming technology is applied to a common signal, a beam sweeping technology is additionally applied such that the signal is transmitted after changing the beam direction, thereby ensuring that the common signal can reach a UE existing at a specific location inside the cell.

As another requirement of 5G systems, an ultra-low latency service is required such that the transmission delay between the transmission and reception ends is about 1 ms or less. In an attempt to reduce the transmission delay, there is a need for frame structure design based on s shorter transmission time interval (TTI) than LTE and LTE-A. The TTI is the basic time unit for performing scheduling, and legacy LTE and LTE-A have a TTI of 1 ms, which corresponds to the length of one subframe. For example, the short TTI, on which 5G systems are based in order to meet the requirement regarding the ultra-low latency service, may be 0.5 ms, 0.25 ms, 0.125 ms, or the like, which is shorter than legacy LTE and LTE-A.

FIG. 1 illustrates the basic structure of a time-frequency resource domain of a 5G system according to an embodiment of the disclosure. That is, FIG. 1 illustrates the basic structure of a time-frequency resource domain which is a radio resource domain used to transmit data or control channels in a 5G system.

Referring to FIG. 1, the horizontal axis denotes the time domain, and the vertical axis denotes the frequency domain. The minimum transmission unit in the time domain of the 5G system is an orthogonal frequency division multiplexing (OFDM) symbol, a group of N_{symb}^{slot} symbols 102 may constitute one slot 106, and a group of N_{symb}^{subframe} slots may constitute one subframe 105. The length of one subframe 105 may be 1.0 ms, and a group of ten subframes may constitute a 10 ms frame 114. The minimum transmission unit in the frequency domain is a subcarrier, and a total of New subcarriers 104 may constitute entire system transmission bandwidth.

The basic unit of a resource in the time-frequency domain is a resource element (RE) 112, which may be described by an OFDM symbol index and a subcarrier index. A resource block (RB) or a physical resource block (PRB) may be defined by N_{sc}^{RB} consecutive subcarriers 110 in the frequency domain. In the 5G system, N_{sc}^{RB}=12, and the data rate may increase in proportion to the number of RBs scheduled for a UE.

In 5G systems, a gNB may map data at the RB level, and may generally schedule RBs constituting one slot with regard to a specific UE. That is, the basic time unit to perform scheduling in 5G systems may be a slot, and the basic frequency unit to perform scheduling may be an RB.

The number (N_{symb}^{slot}) of OFDM symbols is determined according to the length of a cyclic prefix (CP) which is added to each symbol to prevent interference between symbols. For example, if a normal CP is applied, N_{symb}^{slot}=14, and if an extended CP is applied, N_{symb}^{slot}=12. The extended CP is applied to a system having a larger radio-wave transmission distance than the normal CP, thereby maintaining orthogonality between symbols. In the case of the normal CP, the ratio between the CP length and the symbol length may be maintained constant such that overhead caused by the CP is maintained constant regardless of the subcarrier spacing. That is, the symbol length may increase if the subcarrier spacing decreases, thereby increasing the CP length. To the contrary, the symbol length may decrease if the subcarrier spacing increases, thereby decreasing the CP length. The symbol length and the CP length may be inversely proportional to each other.

In order to satisfy various services and requirements in 5G systems, various frame structures may be supported by adjusting the subcarrier spacing. For example:
In terms of the operating frequency band, the larger the subcarrier spacing, the more advantageous for restoration of phase noise in high-frequency bands;
In terms of the transmission time, if the subcarrier spacing increases, the symbol length in the time domain decreases. The resulting decreased the slot length is advantageous for supporting an ultra-low latency service such as URLLC; and/or
In terms of the cell size, the larger the CP length, the larger cell can be supported. Therefore, the smaller the subcarrier spacing, the larger cell is supported. As used herein, a cell refers to a region covered by one gNB in connection with mobile communication.

The subcarrier spacing, the CP length, and the like correspond to information indispensable to OFDM transmission/reception, and a gNB and a UE need to recognize the subcarrier spacing, the CP length, and the like as mutually common values such that efficient transmission/reception is possible. [Table 1] describes the relationship between the subcarrier spacing configuration (μ), the subcarrier spacing (f), and the CP length supported in 5G systems.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

[Table 2] enumerates the number (N_{symb}^{slot}) of slots per one slot, the number of slots (Nₛₗₒₜ^{frame,μ}) per one frame, and the number (Nₛₗₒₜ^{subframe,μ}) of slots per one subframe, with regard to each subcarrier spacing configuration (μ), in the case of a normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

[Table 3] enumerates the number (N_{symb}^{slot}) of slots per one slot, the number of frame (Nₛₗₒₜ^{frame,μ}) per one frame, and the number (Nₛₗₒₜ^{subframe,μ}) of slots per one subframe, with regard to each subcarrier spacing configuration (μ), in the case of an extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

In the early phase of introduction of 5G systems, at least coexistence with legacy LTE and/or LTE-A (hereinafter, referred to as LTE/LTE-A) or dual mode operation is expected. Accordingly, legacy LTE/LTE-A may provide stable system operations to UEs, and 5G systems may play the role of providing improved services to UEs. Therefore, the frame structure of 5G systems need to include at least the frame structure of LTE/LTE-A or an essential parameter set (subcarrier spacing=15 kHz).

For example, a comparison between a frame structure having a subcarrier spacing configuration μ=0 (hereinafter, referred to as frame structure A) and a frame structure having a subcarrier spacing configuration μ=1 (hereinafter, referred to as frame structure B) shows, compared with frame structure A, that frame structure B has double the subcarrier spacing and RB size and half the slot length and symbol length. In the case of frame structure B, two slots may constitute one subframe, and 20 subframes may constitute one frame.

To generalize the framed structure of 5G systems, the subcarrier spacing, the CP length, the slot length, and the like (essential parameter set) are integer multiples with each other with regard to each frame structure, thereby providing a high degree of extendibility. In addition, a subframe having a fixed length of 1 ms may be defined to represent a reference time unit unrelated to the frame structure.

The frame structure of 5G systems may be applied according to various scenarios. In terms of the cell size, the larger the CP length, the larger cells can be supported. Therefore, frame structure A can support larger cells than frame structure B. In terms of the operating frequency band, the larger the subcarrier spacing, the more advantageous for restoration of phase noise in high-frequency bands. Therefore, frame structure B can support higher operating frequencies than frame structure A. In terms of the service, the smaller the slot length (basic time unit of scheduling), the more advantageous for supporting an ultra-low latency service (for example, URLLC). Therefore, frame structure B may be more appropriate for the URLLC service than frame structure A.

As used in the following description of the disclosure, the uplink (UL) may refer to a radio link via which a UE transmits data or control signals to a base station, and the downlink (DL) may refer to a radio link via which the base station transmits data or control signals to the UE.

In an initial access step in which a user equipment initially accesses a system, the user equipment may perform downlink time and frequency domain synchronization and acquire a cell identifier (ID) from a synchronization signal, transmitted by a base station, through a cell search. In addition, the UE may receive a physical broadcast channel (PBCH) by using the acquired cell ID and acquire a master information block (MIB) as mandatory system information from the PBCH. Additionally, the UE may receive system information (system information block (SIB)) transmitted by the base station to acquire cell-common transmission and reception-related control information. The cell-common transmission and reception-related control information may include random access-related control information, paging-related control information, common control information for various physical channels, etc.

A synchronization signal is a signal that serves as a reference for a cell search, and for each frequency band, a subcarrier spacing may be applied adaptively to a channel environment, such as phase noise. For a data channel or a control channel, in order to support various services as described above, a subcarrier spacing may be applied differently depending on a service type.

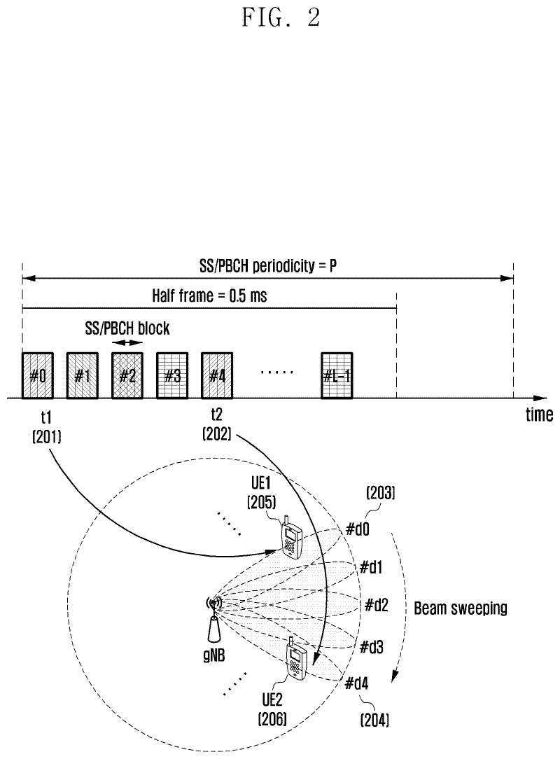

FIG. 2 illustrates an example of a beam sweeping operation and a time domain mapping structure of a synchronization signal according to an embodiment of the disclosure. For the sake of description, the following elements may be defined.
Primary synchronization signal (PSS): A PSS is a signal that serves as a reference for DL time/frequency synchronization, and provides a part of cell ID information.
Secondary synchronization signal (SSS): An SSS serves as a reference for DL time/frequency synchronization, and provides the other part of the cell ID information. Additionally, the SSS may serve as a reference signal for PBCH demodulation of a PBCH.
PBCH: provides an MIB which is mandatory system information necessary for the UE to transmit/receive data channels and control channels. The MIB may include search space-related control information indicating radio resource mapping information of a control channel, scheduling control information for a separate data channel for transmission of system information, a system frame number (SFN) which is a frame unit index that serves as a timing reference, and other information.
Synchronization signal/PBCH block (SS/PBCH block or SSB): An SS/PBCH block is configured by N OFDM symbols and may include a combination of a PSS, an SSS, a PBCH, etc. For a system to which a beam sweeping technology is applied, an SS/PBCH block is a minimum unit to which beam sweeping is applied. In the 5G system, N=4 may be satisfied. A base station may transmit up to a maximum of L SS/PBCH blocks, and the L SS/PBCH blocks are mapped within a half frame (0.5 ms). In addition, the L SS/PBCH blocks are periodically repeated at predetermined periods P. The base station may inform a UE of period P via signaling. If there is no separate signaling of period P, the UE may apply a previously agreed default value. Each SS/PBCH block has an SS/PBCH block index ranging from 0 to maximum L−1, and the user equipment may know the SS/PBCH block index through SS/PBCH detection.

Referring to FIG. 2, FIG. 2 illustrates an example in which beam sweeping is applied in units of SS/PBCH blocks over time. In the example of FIG. 2, a UE 1 205 receives an SS/PBCH block by means of a beam emitted in direction #d0 203 by beamforming applied to SS/PBCH block #0 at time point t1 201. In addition, a UE 2 206 receives an SS/PBCH block by means of a beam emitted in direction #d4 204 by beamforming applied to SS/PBCH block #4 at time point t2 202. The UE may acquire, from the base station, an optimal synchronization signal via a beam emitted in the direction where the UE is located. For example, it may be difficult for a UE 1 205 to acquire time/frequency synchronization and mandatory system information from the SS/PBCH block through the beam emitted in direction #d4 204 far away from the location of a UE 1.

In addition to the initial access procedure, for the purpose of determining whether the radio link quality of a current cell is maintained at a certain level or higher, the UE may also receive the SS/PBCH block. Furthermore, during a handover procedure in which the UE moves access from the current cell to an adjacent cell, the UE may receive an SS/PBCH block of the adjacent cell in order to determine the radio link quality of the adjacent cell and acquire time/frequency synchronization with the adjacent cell.

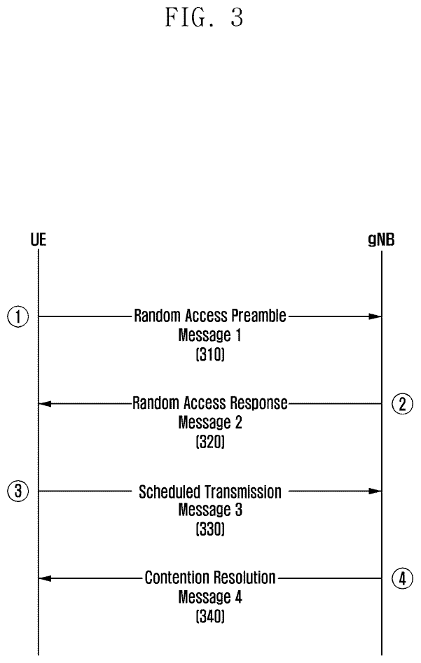

After acquiring an MIB and system information from the base station through the initial access procedure, the UE may perform a random access procedure in order to switch a link to the base station to a connected state (or RRC_CONNECTED state). Upon completing the random access procedure, the UE switches to a connected state in which one-to-one communication between the base station and the UE is possible. Hereinafter, a random access procedure will be described in detail with reference t5o FIG. 3.

FIG. 3 illustrates a random access procedure according to an embodiment of the disclosure.

Referring to FIG. 3, in the first step 310 of the random access procedure, the UE transmits a random access preamble to the gNB. The random access preamble is the first message transmitted by the UE in the random access procedure, and thus may be referred to as message 1. The gNB may measure the transmission delay value between the UE and the gNB from the random access preamble, and may make uplink synchronization. The UE may then arbitrarily select the random access preamble to be used, from a random access preamble set given by system information in advance. The initial transmission power of the random access preamble may be determined by the pathloss between the gNB and the UE, measured by the UE. The UE may also determine the transmission beam direction of the random access preamble from a synchronization signal received from the gNB and then transmit the random access preamble.

In the second step 320, gNB transmits an uplink transmission timing adjustment command to the UE, based on a transmission delay value measured from the random access preamble received in the first step 310. The gNB may also transmit a power control command and an uplink resource to be used by the UE, as scheduling information. The scheduling information may include control information regarding the UE's uplink transmission beam. A message including the above information may be referred to as random access response (RAR) or message 2.

If the UE fails to receive an RAR (or message 2) which is scheduling information regarding message 3 from the gNB within a predetermined time in the second step 320, the UE may perform the first step 310 again. When performing the first step 310 again, the UE may transmit the random access preamble after increasing the transmission power thereof by a predetermined step (power ramping), thereby increasing the probability that the gNB may receive the random access preamble.

In the third step 330, the UE transmits an uplink data (message 3) including the UE ID to the gNB through a physical uplink shared channel (PUSCH) by using the uplink resource allocated thereto in the second step 320. The transmission timing of the PUSCH for transmitting message 3 may follow the timing control command received from the gNB in the second step 320. The transmission power of the PUSCH for transmitting message 3 may be determined in consideration of a power control command received from the gNB in the second step 320 and the random access preamble's power ramping value. The PUSCH for transmitting message 3 may refer to the first uplink data signal transmitted to the gNB by the UE, after transmission of the random access preamble by the UE.

In the fourth step 340, upon determining that the UE has performed a random access without contention with other UEs, the gNB transmits data (message 4) including the ID of the UE which transmitted uplink data in the third step 330 to the corresponding UE. Upon receiving the signal transmitted by the gNB in the fourth step 340 from the gNB, the UE may determine that the random access has succeeded. The UE may then transmit hybrid automatic repeat request-acknowledgement (HARQ-ACK) information to the gNB through a physical uplink control channel (PUCCH) to indicate whether or not message 4 has been received successfully.

If the gNB fails to receive a data signal from the UE due to contention between the data transmitted by the UE in the third step 330 and data from another UE, the gNB may no longer transmit data to the UE. If the UE thus fails to receive data transmitted from the gNB in the fourth step 340 within a predetermined time, the UE may determine that the random access procedure has failed and restart from the first step 310.

Upon successfully completing the random access procedure, the UE is switched to a connected state, and one-to-one communication between the gNB and the UE becomes possible. The gNB may receive UE capability information reported by the UE in the connected state, and may adjust the scheduling with reference to the UE capability information from the UE. The UE may inform the gNB whether the UE itself supports a specific function or not, the maximum allowed value of the function supported by the UE, and the like through the UE capability information. Therefore, UE capability information reported to the gNB by each UE may have a different value with regard to each UE.

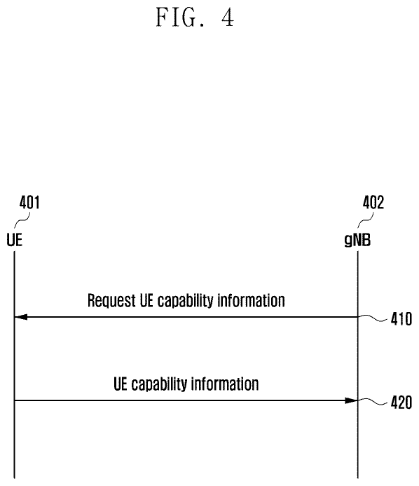

FIG. 4 illustrates a procedure in which a UT reports UE capability information to a gNB according to an embodiment of the disclosure.

Referring to FIG. 4, the gNB 402 may transmit a UE capability information request message to the UE 401 in step 410. The UE transmits UE capability information to the gNB in step 420 at the request for UE capability information of the gNB.

As an example, the UE may report UE capability information including at least one of the following pieces of control information as UE capability information to the gNB:
Control information regarding the frequency band supported by the UE;
Control information regarding the channel bandwidth supported by the UE;
Control information regarding the maximum modulation scheme supported by the UE;
Control information regarding the maximum number of beams supported by the UE;
Control information regarding the maximum number of layers supported by the UE;
Control information regarding the CSI reporting supported by the UE;
Control information regarding the UE supports frequency hopping;
Control information regarding the bandwidth when carrier aggregation (CA) is supported; and/or
Control information regarding whether cross carrier scheduling is supported when CA is supported.

Next, downlink control information (DCI) in a 5G system will be described in detail.

In a 5G system, scheduling information regarding uplink data (or physical uplink shared channel (PUSCH) via which uplink data is transmitted) or downlink data (or physical downlink shared channel (PDSCH) via which downlink data is transmitted) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a RAR message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

With regard to a UE to be scheduled, the gNB may apply and operate a predetermined DCI format according to whether the scheduling information is related to downlink data (downlink assignment), whether the scheduling information is related to uplink data (uplink grant), and whether the DCI is for a purpose other than data scheduling, such as power control.

The gNB may transmit downlink data to the UE through a physical downlink shared channel (PDSCH). Scheduling information such as the specific mapping location of the PDSCH in the time and frequency domains, the modulation scheme, HARQ-related control information, and power control information may be provided from the gNB to the UE through DCI related to downlink data scheduling information among DCI transmitted through a PDCCH.

The gNB may transmit uplink data to the UE through a physical uplink shared channel (PUSCH). Scheduling information such as the specific mapping location of the PUSCH in the time and frequency domains, the modulation scheme, HARQ-related control information, and power control information may be provided from the gNB to the UE through DCI related to uplink data scheduling information among DCI transmitted through a PDCCH.

A time-frequency resource to which a PDCCH is mapped is referred to as a control resource set (CORESET). The CORESET may be configured for all or part of a frequency resource in a bandwidth supported by the UE in the frequency domain. In the time domain, one or multiple OFDM symbols may be configured as a CORESET, and this may be defined as a CORESET duration. The gNB may configure one or multiple CORESETs for the UE through higher layer signaling (for example, system information, MIB, or RRC signaling). The description that a CORESET is configured for the UE may mean that information such as a CORESET identity, the CORESET's frequency location, or the CORESET's symbol length is provided. Pieces of information provided to the UE by the gNB in order to configure a CORESET may include at least some of the pieces of information included in [Table 4].

TABLE 4

| | |
|---|---|
| ControlResourceSet ::= | SEQUENCE { |
| controlResourceSetId | ControlResourceSetId, |

(CORESET identity)

| | |
|---|---|
| frequencyDomainResources | BIT STRING (SIZE (45)), |

(frequency domain resources)

| | |
|---|---|
| duration | INTEGER (1..maxCoReSetDuration), |

(CORESET duration)

| | |
|---|---|
| cce-REG-MappingType | CHOICE { |

(CCE-to-REG mapping type)

| interleaved | SEQUENCE { | |
|---|---|---|
| reg-BundleSize | ENUMERATED {n2, n3, n6}, | |
| | (REG bundle size) | |
| | interleaverSize | ENUMERATED {n2, n3, n6}, |
| | (interleaver size) | |
| | shiftIndex | INTEGER(0..maxNrofPhysicalResourceBlocks-1) |

OPTIONAL -- Need S

(interleaver shift)

},

| | |
|---|---|
| nonInterleaved | NULL |

},

| | |
|---|---|
| precoderGranularity | ENUMERATED {sameAsREG-bundle, allContiguousRBs}, |

(precoding unit)

| | |
|---|---|
| tci-StatesPDCCH-ToAddList | SEQUENCE(SIZE (1..maxNrofTCI- |
| StatesPDCCH)) OF TCI-StateId | OPTIONAL, -- Cond NotSIB1-initialBWP |

(QCL configuration information)

| | |
|---|---|
| tci-StatesPDCCH-ToReleaseList | SEQUENCE(SIZE (1..maxNrofTCI-StatesPDCCH)) |

| | |
|---|---|
| OF TCI-StateId | OPTIONAL, -- Cond NotSIB1-initialBWP |

(QCL configuration information)

| | | |
|---|---|---|
| tci-PresentInDCI | ENUMERATED {enabled} | OPTIONAL, -- Need S |

(QCL indicator configuration information in DCI)

| | | |
|---|---|---|
| pdcch-DMRS-ScramblingID | INTEGER (0..65535) | OPTIONAL, -- Need S |

```
    (PDCCH DMRS scrambling identifier)
  }
```

A CORESET may be configured by N_{RB}^{CORESET} RBs in the frequency domain, and may be configured by N_{symb}^{CORESET}∈{1, 2, 3} symbols in the time domain. An NR PDCCH may be configured by one or multiple control channel elements (CCEs). One CCE may be configured by six resource element groups (REGs), and a REG may be defined as one RB during one OFDM symbol. In one CORESET, REGs may be indexed in the time-first order starting from REG index 0, from the lowest RB of the first OFDM of the CORESET.

As a PDCCH-related transmission method, an interleaved type and a non-interleaved type may be supported. The gNB may configure, for the UE, whether transmission is of the interleaved type or the non-interleaved type with regard to each CORESET through higher layer signaling. Interleaving may be performed at the REG bundle level. A REG bundle may be defined as one REG or a set of multiple REGs. The UE may determine the CCE-to-REG type in the corresponding CORESET, based on the configuration by the gNB regarding whether transmission is of the interleaved type or the non-interleaved type, in a manner as in [Table 5] below.

TABLE 5
The CCE-to-REG mapping for a control-resource set can be interleaved or non-interleaved and is
described by REG bundles:

| | |
|---|---|
| - | REG bundle i is defined as REGs {iL,iL + 1,..., iL + L − 1} where L is the REG bundle size, |
| | i = 0,1, ... , N_{REG}^{CORESET}/ L − 1, and N_{REG}^{CORESET} = N_{RB}^{CORESET}N_{symb}^{CORESET} is the number of REGs in the |
| | CORESET |
| - | CCE j consists of REG bundles {f(6j/L), f(6j/L + 1),..., f(6j/L + 6/L − 1)} where f(•) is |
| | an interleaver |

For non-interleaved CCE-to-REG mapping, L = 6 and f(x) = x.
For interleaved CCE-to-REG mapping, L ∈ {2,6}for N_{symb}^{CORESET} = 1 and L ∈ {N_{symb}^{CORESET}, 6} for
N_{symb}^{CORESET} ∈ {2,3}. The interleaver is defined by

```
  f(x) = (rC + c + n_{shift}) mod (N_{REG}^{CORESET}/ L)
      x = cR + r
      r = 0,1, ... , R − 1
      c = 0,1, ... , C − 1
    C = N_{REG}^{CORESET}/(LR)
```

where R ∈ {2,3,6}.

The gNB may provide configuration information such as to which symbol in the slot the PDCCH is mapped, the transmission cycle, and the like to the UE through signaling.

A description of a search space for a PDCCH is as follows. The number of CCEs necessary to transmit a PDCCH may be 1, 2, 4, 8, or 16 according to aggregation levels (ALs), and different number of CCEs may be used to implement link adaption of a downlink control channel. For example, in the case of AL=L, one downlink control channel may be transmitted through L CCEs. The UE performs blind decoding for detecting a signal while being no information regarding the downlink control channel, and to this end, a search space indicating a set of CCEs may be defined. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

The search spaces may be classified into common search spaces (CSSs) and UE-specific search spaces (USSs). A group of UEs or all UEs may search a common search space of the PDCCH in order to receive cell-common control information such as dynamic scheduling regarding system information (SIB) or a paging message. For example, the UE may receive PDSCH scheduling allocation information for reception of system information by searching the common search space for the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space for the PDCCH. The UE-specific search space may be defined UE-specifically as a function of various system parameters and the ID of the UE.

Configuration information of the search space for the PDCCH may be configured for the UE by the base station through higher layer signaling (e.g., SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, parameters of the search space for the PDCCH may include the following pieces of information given in Table 6 below.

TABLE 6

| | |
|---|---|
| SearchSpace ::= | SEQUENCE { |
| searchSpaceId | SearchSpaceId, |

(search space identity)

| | | |
|---|---|---|
| controlResourceSetId | ControlResourceSetId | OPTIONAL, -- Cond SetupOnly |

(CORESET identity)

| | |
|---|---|
| monitoringSlotPeriodicityAndOffset | CHOICE { |

(monitoring slot level periodicity and offset)

| sl1 | NULL, | |
|---|---|---|
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639), | |
| sl1280 | INTEGER (0..1279), | |
| sl2560 | INTEGER (0..2559) | |
| } | OPTIONAL, -- Cond Setup | |
| duration | INTEGER (2..2559) | OPTIONAL, -- Need R |

(monitoring duration)

| | |
|---|---|
| monitoringSymbolsWithinSlot | BIT STRING (SIZE (14)) OPTIONAL, -- Cond Setup |

(monitoring symbol locations within slot)

| | |
|---|---|
| nrofCandidates | SEQUENCE { |

(number of PDCCH candidates for each aggregation level )

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| } | OPTIONAL, -- Cond Setup |
| searchSpaceType | CHOICE { |

(search space type)

| | |
|---|---|
| common | SEQUENCE { |

```
      (common search space )
  dci-Format0-0-AndFormat1-0 SEQUENCE {
  ...
```

| } | OPTIONAL, -- Need R | |
|---|---|---|
| dci-Format2-0 | SEQUENCE { | |
| nrofCandidates-SFI | SEQUENCE { | |
| aggregationLevel1 | ENUMERATED {n1, n2} | OPTIONAL, -- Need R |
| aggregationLevel2 | ENUMERATED {n1, n2} | OPTIONAL, -- Need R |
| aggregationLevel4 | ENUMERATED {n1, n2} | OPTIONAL, -- Need R |
| aggregationLevel8 | ENUMERATED {n1, n2} | OPTIONAL, -- Need R |
| aggregationLevel16 | ENUMERATED {n1, n2} | OPTIONAL -- Need R |

```
  },
  ...
```

| | |
|---|---|
| } | OPTIONAL, -- Need R |
| dci-Format2-1 | SEQUENCE { |

...

| | |
|---|---|
| } | OPTIONAL, -- Need R |
| dci-Format2-2 | SEQUENCE { |

...

| } | OPTIONAL, -- Need R | |
|---|---|---|
| dci-Format2-3 | SEQUENCE { | |
| dummy1 | ENUMERATED {sl1, sl2, sl4, sl5, | OPTIONAL, -- |

sl8, sl10, sl16, sl20}

Cond Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |

(UE-specific search space)

| | |
|---|---|
| dci-Formats | ENUMERATED {formats0-0-And-1-0, |
| | formats0-1-And-1-1}, |

```
  ...,
  }
```

| | |
|---|---|
| } | OPTIONAL -- Cond Setup2 |

}

According to configuration information, the base station may configure one or multiple search space sets for the UE. According to some embodiments, the base station may configure search space set 1 and search space set 2 for the UE. In search space set 1, the UE may be configured to monitor DCI format A scrambled by an X-RNTI in a common search space, and in search space set 3, the UE may be configured to monitor DCI format B scrambled by a Y-RNTI in a UE-specific search space.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

In a common search space, the UE may monitor combinations of DCI formats and RNTIs given below. Obviously, the example given below is not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

In a UE-specific search space, the UE may monitor combinations of DCI formats and RNTIs given below. Obviously, the example given below is not limiting:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

The RNTIs may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and/or
Transmit power control for SRS RNTI (TPC-SRS-RNTI): used to indicate a power control command regarding an SRS.

The DCI formats enumerated above may follow the definitions given in Table 7 below.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no |
| | transmission is intended for the UE |
| 2_2 | Transmission of TPC commands for PUCCH and PUSCH |
| 2_3 | Transmission of a group of TPC commands for SRS |
| | transmissions by one or more UEs |

The search space at aggregation level L in connection with CORESET p and search space set s may be expressed by Equation 1 below:

$$L \cdot \{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{CCE , p}}{L} ⌋ \} + i L : aggregation level ; {n}_{CI} : carrier index ; {N}_{C C E , p} : total number of CCEs exisiting in control resource set p ; {n}_{s , f}^{μ} : slot index ; {M}_{s , max}^{( L )} : number of PDCCH candidates at aggregation level L ; {m}_{s , {n}_{CI}} = 0 , … , {M}_{s , max}^{( L )} - 1 : PDCCH candidate index at aggregation level L ; i = 0 , … , L - 1 ; and {Y}_{p , {n}_{s , f}^{μ}} = ( {A}_{p} \cdot {Y}_{p , {n}_{s , f}^{μ} - 1} ) mod D , \\ {Y}_{p , - 1} = {n}_{RNTI} \neq 0 , \\ {A}_{p} = 39827 for pmod 3 = 0 , {A}_{p} = 39829 for pmod 3 = 1 , {A}_{p} = 39839 for pmod 3 = 2 , D = 6 5537. \qquad [ Equation 1 ]$$

The Y_{p,n}_{_{s,f}}^{μ} value may correspond to 0 in the case of a common search space.

The Y_{p,n}_{_{s,f}}^{μ} value may correspond to a value changed by the UE's identity (C-RNTI or ID configured for the UE by the base station) and the time index in the case of a UE-specific search space.

The data rate may be increased through a spatial multiplexing method which uses multiple transmission/reception antennas, as a scheme for supporting a super-fast data service. In general, the number of necessary power amplifiers (PAs) increases in proportion to the number of transmission/reception antennas provided in a gNB or a UE. The maximum output of the gNB and the UE depends on PA characteristics, and the gNB's maximum output generally varies depending on the size of the cell covered by the gNB. The maximum output is commonly indicated using a dBm unit. The UE's maximum output is commonly 23 dBm or 26 dBm.

An exemplary commercial 5G gNB may have 64 transmission antennas in a frequency band of 3.5 GHz and 64 PAs corresponding thereto, and may operate in a bandwidth of 100 MHz. Consequently, the amount of energy consumed by the gNB increases in proportion to the PA's output and the PA's operating time. Compared with LTE gNBs, 5G gNBs are characterized by having a broad bandwidth and many transmission antennas due to higher operating frequency bands. Such characteristics have the advantage of a high data rate, but incur the cost of increased amount of energy consumed by the gNB. Therefore, the entire energy consumed by a mobile communication network increases in proportion to the number of gNBs constituting the mobile communication network.

As described above, energy consumption by a gNB depends on PA operations. PAs are involved in gNB transmission operations, and the gNB's downlink transmission operation is highly related to the gNB's energy consumption. Physical channels and physical signals transmitted through the downlink by the gNB are as follows:
PDSCH: a downlink data channel including data to be transmitted to one or multiple UEs;
PDCCH: a downlink control channel including scheduling information regarding a PDSCH and a PUSCH. Alternatively, the PDCCH alone may transmit control information such as a slot format and a power control command without a PDSCH or PUSCH to be scheduled. Scheduling information includes information regarding resources to which the PDSCH or PUSCH is mapped, HARQ-related information, power control information, and the like;
PBCH: a downlink broadcast channel for providing MIB which is essential system information necessary for the UE's data channel and control channel transmission/reception;
PSS: is a signal serving as a reference for time/frequency synchronization, and provides cell ID partial information;
SSS: a signal which serves as a reference for DL time and/or frequency (hereinafter, referred to as time/frequency) synchronization, and which provides cell ID remaining partial information;
Demodulation reference signal (DM-RS): a reference signal for the UE's channel estimation regarding each of the PDSCH, PDCCH, and PBCH;
Channel-state information reference signal (CSI-RS): a downlink signal serving as a reference for the UE's downlink channel state measurement; and
Phase-tracking reference signal (PT-RS): a downlink signal for phase tracking.

Compared with the gNB's downlink transmission operation, the gNB's uplink reception operation does not occupy a relatively high proportion of energy consumption by the gNB. Physical channels and physical signals transmitted through the uplink by the gNB are as follows:
PUSCH: an uplink data channel including data transmitted to the gNB by the UE;
PUCCH: an uplink control channel including control information transmitted to the gNB by the UE, such as channel state information, HARQ-ACK information, and the like;
Physical random access channel (PRACH): a random access preamble transmitted to the gNB by the UE in order to perform a random access procedure;
DM-RS: a reference signal for the gNB's channel estimation regarding each of the PUSCH and the PUCCH;
PT-RS: an uplink signal for phase tracking; and/or
Sounding reference signal (SRS): an uplink signal serving as a reference for the gNB's uplink channel state measurement.

In terms of the gNB's energy saving, if the gNB stops the downlink transmission operation, the PA operation stops accordingly, thereby contributing to the gNB's energy saving. Not only the PAs, but also other gNB devices (for example, baseband devices) have reduced operations, thereby additionally saving the energy. Likewise, additional energy saving is possible if it is possible to stop the uplink reception operation, although the uplink reception operation occupies a relatively small proportion in the entire energy consumption by the gNB.

The gNB's downlink transmission operation depends on the amount of downlink traffic. For example, if there is no data to be transmitted to the UE through the downlink, the gNB has no need to transmit a PDSCH and a PDCCH for scheduling the PDSCH. Alternatively, if transmission can be suspended for a while because data is not sensitive to transmission delay, for example, the gNB may not transmit the PDSCH and/or the PDCCH. Hereinafter, a method for reducing the gNB's energy consumption by transmitting no PDSCH and/or PDCCH related to data traffic, or by appropriately adjusting the same, as described above, will be referred to as “gNB energy saving method 1-1” for convenience of description.

To the contrary, physical channels and physical signals such as PSS, SSS, PBCH, and CSI-RS are characterized in that they are repeatedly transmitted at a promised cycle, regardless of data transmission regarding the UE. Therefore, the UE may continuously update the downlink time/frequency synchronization, the downlink channel state, the radio link quality, and the like although no data is received. That is, the PSS, SSS, PBCH, and CSI-RS need to be transmitted through the downlink regardless of the downlink data traffic, and this causes energy consumption by the gNB. Therefore, the gNB's energy consumption may be reduced by making adjustment such that transmission of signals having no (or little) relevance to data traffic occurs less frequently (hereinafter, referred to as “gNB energy saving method 1-2”).

Through “gNB energy saving method 1-1” or “gNB energy saving method 1-2,” operations of RF devices, baseband devices, and the like related to the gNB's PA operations may be stopped or minimized during a time interval in which the gNB makes no downlink transmission, thereby maximizing the gNB's energy saving. In the disclosure, an operation to which an idle time interval is applied in connection with gNB transmission as described above will be referred to as cell discontinuous transmission (cell DTX). As a similar concept, an operation to which an idle time interval is applied in connection with the gNB reception operation will be referred to as cell discontinuous reception (cell DRX).

As another method, some of the gNB's antennas or PAs may be switched off, thereby reducing the gNB's energy consumption (hereinafter, referred to as “gNB energy saving method 2”). In this case, the gNB's energy saving may involve a countereffect such as reduced cell coverage or reduced throughput. For example, there may be a gNB which has 64 transmission antennas in a frequency band of 3.5 GHz and 64 PAs corresponding thereto, and which operates in a bandwidth of 100 MHz, as described above. If four transmission antennas and four PAs are activated during a predetermined time interval to save the gNB's energy as described above, and if the remainders are switched off, the energy consumption by the gNB is reduced to about 1/16 (=4/64) during the time interval. If four transmission antennas and four PAs are activated during a predetermined time interval, and if the remainders are switched off, it may be difficult to accomplish the cell coverage and throughput based on an assumption of 64 antennas and PAs as usual, due to the reduced maximum transmission power and reduced beamforming gain.

In the following description, a gNB mode to which operations for gNB energy saving (distinguished from normal gNB operations) are applied will be referred to as a gNB energy saving (ES) mode, and a gNB mode to which normal gNB operations are applied will be referred to as a gNB normal mode.

If the gNB operates in a gNB energy saving mode through a method such as cell DTX or cell DRX in order to reduce energy consumption by the gNB in the above description, a corresponding transmission/reception operation of the UE needs to be defined.

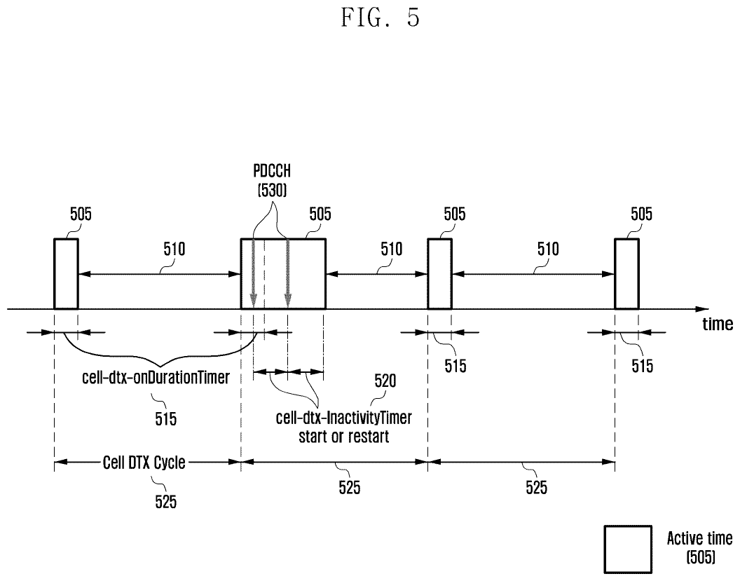

Hereinafter, the concept of the cell DTX operation will be described with reference to FIG. 5.

If cell DTX is applied, the gNB may turn on the transmitter at a specific timepoint so as to transmit a downlink signal. If there is no signal to be transmitted to the UE for a predetermined period of time, the gNB may turn off the transmitter or simplify the transmission processing, thereby reducing the gNB's power consumption. The cell DTX operation may be controlled based on various parameters and timers.

Referring to FIG. 5, during the active time 505, the gNB wakes up at each cell DTX cycle 525 and transmits a downlink signal. The downlink signal transmitted by the gNB during the active time 505 is the same as in the case of the exiting gNB normal mode. The active time 505 may be configured by parameters such as cell-dtx-onDurationTimer, cell-dtx-Inactivity Timer, cell-dtx-RetransmissionTimerDL, cell-dtx-RetransmissionTimerUL, and ra-ContentionResolutionTimer. These parameters correspond to timers, the value of which is configured by the gNB, and which are signaled to the UE, and have functions of configuring the gNB's downlink signal transmission and the UE's downlink signal reception in a situation in which a predetermined condition is satisfied.

cell-dtx-onDuration Timer 515 is a parameter for configuring the minimum time for which the gNB or the UE is awake. cell-dtx-InactivityTimer 520 is a parameter for configuring a time for which the gNB or the UE is additionally awake when the gNB transmits a PDCCH 530 indicating new uplink data transmission or downlink data transmission. cell-dtx-RetransmissionTimerDL (not illustrated) is a parameter for configuring the maximum time for which the gNB or the UE is awake in order to perform downlink retransmission in a downlink HARQ procedure. cell-dtx-RetransmissionTimerUL (not illustrated) is a parameter for configuring the maximum time for which the gNB or the UE is awake when an uplink retransmission grant is transmitted in an uplink HARQ procedure. cell-dtx-onDurationTimer, cell-dtx-Inactivity Timer, cell-dtx-RetransmissionTimerDL, and cell-dtx-RetransmissionTimerUL may be configured by using the time, the number of subframe, the number of slots, and the like, for example. ra-ContentionResolution Timer (not illustrated) is a parameter used by the UE to monitor the PDCCH in the random access procedure.

The inactive time 510 is configured such that the gNB transmitter is turned off during the cell DTX operation, or such that the gNB simplifies gNB transmission processing. The remaining time other than the active time 505, during the entire time for which the cell DTX operation is performed, may be the inactive time 510. In the cell DTX operation, the gNB may enter the inactive time if there occurs no data traffic to be transmitted to the UE by the gNB. That is, no PDSCH or PDCCH related to the UE's data traffic occurs during the inactive time. In order to simplify gNB transmission processing during the inactive time, adjustment may be made such that transmission of signals (for example, PSS, SSS, PBCH, and CSI-RS) having no (or little) relevance to data traffic occurs less frequently, thereby saving gNB energy. If necessary, transmission of the PSS, SSS, PBCH, and CSI-RS may be suspended during the inactive time.

If no signal to be transmitted to the UE by the gNB occurs during the active time 505, the gNB may enter a sleep or inactive state, thereby reducing power consumption. Likewise, if the UE receives no PDCCH from the gNB during the active time 505, the UE may enter a sleep or inactive state, thereby reducing power consumption.

The cell DTX cycle refers to a cycle at which the gNB wakes up and perform normal downlink signal transmission. As described above, during the cell DTX cycle, an active time and an inactive time occur alternatively. While operating for the cell DTX, the gNB restarts cell-dtx-onDurationTimer 515 at a timepoint which has elapsed a cell DTX cycle 525 from the starting point (for example, starting symbol) of cell-dtx-onDurationTimer 515. When operating at the cell DTX cycle 525, the gNB may start cell-dtx-onDurationTimer 515 in a slot after cell-dtx-SlotOffset since a subframe satisfying [Equation 2] below. As used herein, cell-dtx-SlotOffset refers to a delay before cell-dtx-onDurationTimer 515 is started. cell-dtx-SlotOffset may be configured by the time, the number of slots, and the like, for example.

$$[ ( SFN \times 10 ) + subframe number ] modulo ( cell ‐ dtx ‐ Cycle ) = cell ‐ dtx ‐ StartOffset . \qquad [ Equation 1 ]$$

Where cell-dtx-Cycle and cell-dtx-StartOffset may be used to define a subframe to start a cell DTX cycle 525. cell-dtx-Cycle and cell-dtx-StartOffset may be configured by the time, the number of subframes, the number of slots, and the like, for example, and may be indicated to the UE by the gNB through signaling.

Although FIG. 5 has been described from the viewpoint of the gNB's cell DTX, gNB transmission operations in the above description may be replaced with gNB reception operations such that the same is generalized as gNB cell DRX operations and then applied. The gNB may independently configure and operate cell DTX operations and cell DRX operations, respectively, or may combine and operate the same.

Hereinafter, a UE's uplink signal transmission method and downlink signal reception method, assuming that a gNB operates in a gNB energy saving mode through a method such as cell DTX or cell DRX, provided in the disclosure will be described through specific embodiments.

### First Embodiment

In the first embodiment, a method for determining a reference signal for pathloss measurement for controlling a UE's uplink transmission power control, assuming that a gNB operates in a gNB energy saving mode through a method such as cell DTX or cell DRX, will be described.

A method for determining transmission power of the PUSCH will first be described in detail.

In a 5G system, transmission power of the PUSCH may be determined through [Equation 3] as follows. The transmission power of the PUSCH is determined by a serving cell c in which the PUSCH is transmitted, a bandwidth part (BWP) b, a PUSCH transmission occasion i (a time interval during which the PUSCH is transmitted), and the like.

$$[ Equation 3 ]$$

$${P}_{PUSCH , b , f , c} ( i , j , {q}_{d} , l ) = min \{ \text{} \begin{matrix}{P}_{CMAX , f , c} ( i ) , \\ \begin{matrix}{P}_{O\_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix}\end{matrix} \} [ dBm ] .$$

In [Equation 3], j varies depending on the data type of the PUSCH. If the PUSCH is the UE's uplink data transmission in a random access procedure, j=0. If scheduling information regarding the PUSCH is uplink data transmission according to a predefined configured grant which is maintained with no change during a predetermined time interval, j=1. If the PUSCH is data dynamically scheduled by a PDCCH, j∈{2, 3, . . . , J−1} is applied:
P_{CMAX,f,c}(i) is the UE's maximum output power, and is determined by the UE with reference to the UE's power class and a configuration of upper signaling from the gNB;
P_{O_PUSCH,b,f,c}(j) is a value configured and operated by the gNB for the UE in order to respond to the semi-static channel state between the UE and the gNB, such as uplink interference;
α_{b,f,c}(j) is a value for compensating for pathloss, and may be determined through a higher layer configuration and an SRS resource indicator (SRI) (in the case of a dynamic grant PUSCH);
PL_{b,f,c}(q_{d}) is a downlink pathloss estimation value estimated by the UE through a reference signal having a reference signal index of q_{d}. The UE may calculate the pathloss from the difference between transmission power of a reference signal signaled by the gNB and the reception signal level of the reference signal measured by the UE. The reference signal index of q_{d} may be determined through a higher layer signaling, and the SSB or CSI-RS may be a reference signal for pathloss calculation;
M_{RB,b,f,c}^{PUSCH}(i) refers to the gNB's frequency-domain scheduling resource allocation value expressed by the number of RBs;
Δ_{TF,b,f,c}(i) refers to a value determined according to the modulation and coding scheme (MCS), the type of information transmitted through the PUSCH (for example, whether the UL-SCH is included or not, whether the CSI is included or not, or the like), and the like;
f_{b,f,c}(i,l) refers to a closed-loop power control adjustment state, and may be supported in an accumulation type and in an absolute type. The gNB may inform the UE in which type power control adjustment is to be performed, through signaling. In the case of the accumulation type, f_{b,f,c}(i,l) is determined by a closed-loop power control adjustment state regarding the previous PUSCH transmission occasion i−i₀, and the sum

$${f}_{b , f , c} ( i - {i}_{0} , l ) + {\sum }_{m = 0}^{𝒸 ( {D}_{i} ) - 1} ( m , l )$$

of TPC command values regarding closed-loop index 1 received through DCI, between symbol K_{PUSCH}(i−i₀)−1 prior to transmission of PUSCH transmission occasion i−i₀ and symbol K_{PUSCH}(i) prior to transmission of PUSCH transmission occasion i. In the case of the absolute type, is f_{b,f,c}(i,l) is determined by a TPC command value δ_{PUSCH,b,f,c}(i,l) regarding closed-loop index 1 received through DCI. The closed-loop index 1 may be 0 or 1 if higher layer parameter twoPUSCH-PC-AdjustementStates is configured for the UE, and may have a value determined through a higher layer configuration and SRI (in the case of a dynamic grant PUSCH). The mapping relationship between a TPC command field in DCI and a TPC value δ_{PUSCH,b,f,c}, according to the accumulation type and the absolute type, may be defined as in [Table 8] below:

TABLE 8

| TPC | Accumulated | Absolute |
|---|---|---|
| command | δ_{PUSCH, b, f, c} | δ_{PUSCH, b, f, c} |
| field | [dB] | [dB] |
| 0 | −1 | −4 |
| 1 | 0 | −1 |
| 2 | 1 | 1 |
| 3 | 3 | 4 |

The first embodiment is a solution to the following problem: in a system to which the above-described UE transmission power procedure is applied, if a cell DTX operation is activated to save gNB energy, and if the gNB simplifies the downlink signal transmission operation during an inactive time, the reference signal referenced to calculate the UE's pathloss is absent or insufficient, and the UE's transmission power control accuracy may degrade. The following method may be applied to solve this problem according to the first embodiment.

Method 1: among one or more reference signals (Set A) for pathloss calculation configured for the UE by the gNB in a legacy gNB normal mode, the gNB may designate reference signals (Set B) to be used for pathloss calculation by the UE during an inactive time of cell DTX, and may inform the UE thereof (Set A⊃Set B). As an example, information for designating Set A and/or Set B may be a set (or list) including at least one of the index, a resource index, and a resource set index of a reference signal (for example, SSB, CSI-RS). Alternatively, information for designating Set B may be information indicating the index or ID of at least one reference signal included in Set A. Thereafter, the UE may receive indication of the index or ID of a reference signal belonging to Set A and/or Set B from the gNB, may receive indication of information regarding the index or ID of a reference signal belonging to Set A and/or Set B from the gNB, or may use a reference signal belonging to Set A and/or Set B determined according to a predetermined method, thereby calculating the pathloss. Alternatively, the gNB may directly configure the index of a reference signal or a resource index for the UE such that the pathloss is calculated by using a reference signal belonging to Set A or a reference signal belonging to Set B. It is also possible to configure information related to the reference signal's transmission power together with the above-described information for indicating the reference signal. As an example, information related to the SSB's transmission power may be “ss-PBCH-BlockPower, and information related to the CSI-RS”s transmission power may be ss-PBCH-BlockPower and powerControlOffsetSS.

Accordingly, the gNB transmits a reference signal belonging to Set B during the inactive time of cell DTX such that the UE can use the reference signal for pathloss calculation. In addition, during the cell DTX inactive time, the UE calculates the pathloss with reference to the reference signal belonging to Set B. If it is not the inactive time of cell DTX, if the cell DTX operation is not activated, or if no cell DTX configuration has been made, the gNB transmits a reference signal belonging to Set A, thereby supporting the UE's pathloss calculation.

A downlink pathloss value PL_{b,f,c}(q_{d}) calculated by the UE through a reference signal, the reference signal index of which is q_{d}, may be calculated as in [Equation 4] below:

$${PL}_{b , f , c} ( {q}_{d} ) = referenceSignalPower - higher layer filtered RSRP . \qquad [ Equation 4 ]$$

wherein “referenceSignalPower” refers to a transmission power value of reference signal q_{d}, and “higher layer filtered RSRP” refers to received signal power of reference signal q_{d} calculated through additional processing (for example, filtering) by the UE upon receiving the reference signal q_{d}.

as a special case of method 1, the Set B may be fixed by an SSB. If there are multiple SSBs, the UE may receive information indicating the index or ID or time/frequency location of one of SSBs from the gNB through higher layer signaling or/and L1 signaling, or a specific SSB among the same may be prefixed as a reference signal which may be referenced for pathloss measurement. Therefore, if Set B is fixed by one specific SSB, the gNB has no need to inform the UE of Set B through separate signaling, and the UE and the gNB may have a mutually common understanding with regard to the reference signal for pathloss measurement during the cell DTX inactive time interval. The single specific SSB may be determined in advance. In addition, different SSBs among multiple SSBs may be configured for respective UEs.

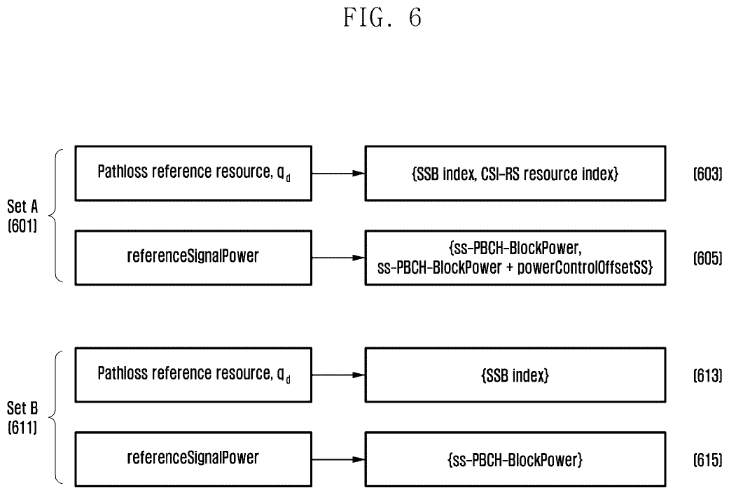

FIG. 6 illustrates a detailed method of method 1. Referring to FIG. 6, Set A 601 is information regarding a reference signal which may be referenced by the UE for pathloss measurement during an active time, and includes, for example, the index 603 of a reference signal for pathloss measurement, and transmission power 605 of the reference signal for pathloss measurement. Although FIG. 6 illustrates an example in which one SSB and one CSI-RS are configured as a reference signal for pathloss measurement, but the example is not limitative. In the illustrated example, the SSB's transmission power is “ss-PBCH-BlockPower,” and the CSI-RS's transmission power is “ss-PBCH-BlockPower+powerControlOffsetSS” which has a difference of “powerControlOffsetSS” compared with SSB transmission power. Likewise, Set B is information regarding a reference signal which may be referenced by the UE for pathloss measurement during an inactive time, and includes, for example, the index 613 of a reference signal for pathloss measurement, and transmission power 615 of the reference signal for pathloss measurement, but the example is not limitative. As described in FIG. 6, Set B is included in Set A, and one of reference signals of Set A, SSB, is configured as a reference signal for pathloss measurement of Set B as an example. In addition, in the illustrated example, the SSB's transmission power is “ss-PBCH-BlockPower.”

Method 2: unlike method 1 described above, the condition for Set A and Set B to include each other is removed in method 2, thereby enabling more flexible gNB operations. That is, a reference signal for pathloss calculation in a gNB normal mode and a reference signal for pathloss calculation during an inactive time interval of cell DTX may be independently configured and operated without separate restrictions. Accordingly, the gNB may inform the UE of detailed configuration information of Set A and Set B through signaling. As an example, the gNB may transmit a set (or list) including at least one of the index, a resource index, and a resource set index of a signal (for example, SSB, CSI-RS) to the UE, as information designating Set A and/or Set B, as described above. Thereafter, the gNB may transmit information indicating a reference signal belonging to Set A to be referenced for pathloss measurement during an active time and/or a reference signal belonging to Set B to be referenced for pathloss measurement during an inactive time to the UE. Alternatively, the gNB may directly configure the index of a reference signal or a resource index for the UE such that the pathloss is calculated by using a reference signal belonging to Set A or a reference signal belonging to Set B. It is also possible to configure information related to the reference signal's transmission power together with the above-described information for indicating the reference signal.

During the cell DTX inactive time, the UE calculates pathloss with reference to the indicated reference signal belonging to Set B. If it is not the inactive time of cell DTX, if the cell DTX operation is not activated, or if no cell DTX configuration has been made, the UE calculates pathloss by using the reference signal belonging to Set A.

Although a method for controlling the UE's transmission power, when the UE transmits a PUSCH, has been described in the first embodiment, the same may also be applied to transmission of other uplink channels or signals (for example, when the UE transmits a PUCCH or a random access preamble).

The first embodiment may be variously modified. For example, the operating condition of Set A and Set B may be associated with a gNB energy saving operation in which the gNB's antennas or PAs are adjusted, instead of being associated with a cell DTX operation. That is, a reference signal included in Set A may be transmitted based on a gNB antenna or PA configuration in a gNB normal mode, and the UE may measure pathloss, based on the reference signal belonging to Set A, in the gNB normal mode. A reference signal included in Set B may be transmitted based on a configuration in a gNB energy saving mode in which gNB antennas or PAs are adjusted, and the UE may measure pathloss, based on the reference signal belonging to Set B, in the gNB energy saving mode. The UE may determine uplink transmission power, based on each measured pathloss.

### Second Embodiment

In the second embodiment, a method for determining a power control adjustment state for the UE's uplink transmission power control, when the gNB operates in a gNB energy saving mode through a method such as cell DTX or cell DRX, will be described.

As described above, f_{b,f,c}(i,l) in [Equation 3] above is a closed-loop power control adjustment state. In the case of an accumulation type, f_{b,f,c}(i,l) is updated by reflecting f_{b,f,c}(i,l) which has been maintained/managed by the UE until the present time, and TPC command values regarding PUSCH transmission for a predetermined time interval from the present time. In the case of an absolute type, a TPC command value regarding a PUSCH to be transmitted by the UE at the present time is applied as the f_{b,f,c}(i,l) value. Operations in the second embodiment will now be described with reference to FIG. 5.

When switching from the inactive time 510 to the active time 505 according to the gNB's cell DTX operation in the example of FIG. 5, the power control adjustment state needs to be applied differently from existing cases. For example, if the inactive time lasts for a considerable period of time, or if the cell DTX cycle value is configured long such that the inactive time occupies a relatively large proportion in the entire cell DTX cycle, the gNB loses an opportunity to transmit a TPC command to the UE during the inactive time according to the cell DTX operation, and the accuracy of uplink transmission power control regarding the UE may deteriorate. Therefore, when switching from the inactive time to the active time according to the cell DTX operation, the UE may preferably initialize the power control adjustment state and apply f_{b,f,c}(i,l)=0. That is, if at least one of the following conditions is satisfied, the UE initializes the power control adjustment state for uplink transmission power control to f_{b,f,c}(i,l)=0.

Condition 1: a case in which the inactive time is larger (or longer) than a promised time's threshold. The threshold may be configured by the gNB and indicated to the UE through higher layer signaling, for example, or may be predetermined.

Condition 2: a case in which the cell DTX cycle value is configured long such that the inactive time occupies a relatively large proportion in the entire cell DTX cycle. The proportion may be configured by the gNB and indicated to the UE through higher layer signaling, for example, or may be predetermined.

Condition 3: a case in which the gNB performs the cell DTX operation and then no longer performs the cell DTX operation.

Alternatively, if the transmission power control type is the accumulation type, and if the above condition is satisfied, the UE may assume that the value of a TPC command transmitted by the gNB is “0” and may adjust uplink transmission power (alternatively, the gNB may configure the value of TPC command to be 0” and may transmit the same to the UE).

Additionally, the above operation may be applied only to an accumulation type in which the power control operation considers the past PUSCH transmission power together. In the case of the absolute type, the TPC command regarding the current PUSCH transmission is reflected in the power control adjustment state, and the accuracy of transmission power control may not be degraded even if the existing operation is applied as it is. Alternatively, when the gNB performs the cell DTX operation, the gNB may operate transmission power control regarding the UE in the absolute type. For example, even if transmission power control regarding the UE in the gNB normal mode is the accumulate type, the transmission power control type regarding the UE may be switched to the absolute type and then applied without a separate modification procedure through signaling in the gNB transmission energy saving mode in which cell DTX is applied.

As described above, initializing the power control adjustment state f_{b,f,c}(i,l) to 0 is only an example. It is also possible to initialize the same to a specific value. The specific value may be configured by the gNB or predetermined.

The above-described operation may be applied to a case of switching from the inactive time to the active time according to the cell DTX operation, and the existing transmission power control operation may be maintained in the opposite case of switching from the active time to the inactive time.

The second embodiment may be modified variously. For example, the same may be likewise applied to a gNB energy saving operation in which the gNB's antennas or PAs are adjusted. Operations of the gNB and the UE during the active time described above may be applied to a gNB normal mode, and operations of the gNB and the UE during the inactive time described above may be applied to a gNB energy saving mode.

### Third Embodiment

In the third embodiment, a method for configuring the UE's QCL, when the gNB operates in a gNB energy saving mode through a method such as cell DTX or cell DRX, will be provided.

In a wireless communication system, one or more different antenna ports (which may also be replaced with one or more channels, signals, and combinations thereof, but will hereinafter be referred to as different antenna ports for convenience of description) may be associated with each other by a quasi co-location (QCL) configuration as in [Table 9] below. A TCI state is used to publicize the QCL relationship between a PDCCH (or PDCCH DMRS) and another RS or channel. The description that a reference antenna port A (reference RS #A) and another target antenna port B (target RS #B) are QCLed with each other means that the UE is allowed to apply all or some of large-scale channel parameters estimated in the antenna port A to channel measurement from the antenna port B. QCL may need to associate different parameters, depending on the situation, such as 1) time tracking affected by average delay and delay spread, 2) frequency tracking affected by Doppler shift and Doppler spread, 3) radio resource management (RRM) affected by average gain, and 4) beam management (BM) affected by spatial parameters. Accordingly, NR supports for types of QCL relationships as in [Table 9] below:

TABLE 9

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameters may refer to some or all of various parameters such as angle of arrival (AoA), power angular spectrum (PAS) of AoA, angle of departure (AoD), PAS of AoD, transmit/receive channel correlation, transmit/receive beamforming, and spatial channel correlation.

The QCL relationship may be configured for the UE through an RRC parameter TCI-State and QCL-Info as in [Table 10] below. Referring to [Table 10], the gNB may configure one or more TCI states for the UE so as to indicate a maximum of two kinds of QCL relationship (qcl-Type1 and qcl-Type2) regarding the RS which references the ID of the TCI state (that is, target RS). Each piece of QCL information (QCL-Info) which each TCI state includes the serving cell index and BWP index of the reference RS indicated by corresponding QCL information, the type and ID of the reference RS, and a QCL type as in [Table 9] above.

TABLE 10

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) which references
corresponding TCI state ID)

| | |
|---|---|
| qcl-Type2 | QCL-Info |

```
      OPTIONAL, -- Need R
  (QCL information of second reference RS of RS (target RS) which references
corresponding TCI state ID)
  ...
}
```

| | |
|---|---|
| QCL-Info ::= | SEQUENCE { |
| cell | ServCellIndex |

```
    OPTIONAL, -- Need R
  (serving cell index of reference RS indicated by corresponding QCL
information)
```

| | |
|---|---|
| bwp-Id | BWP-Id |

```
        OPTIONAL, -- Cond CSI-RS-Indicated
  (BWP index of reference RS indicated by corresponding QCL information)
```

| | |
|---|---|
| referenceSignal | CHOICE { |
| csi-rs | NZP-CSI-RS-ResourceId, |
| ssb | SSB-Index |

(one of CSI-RS ID or SSB ID indicated by corresponding QCL
information)

| | |
|---|---|
| }, | ENUMERATED {typeA, |

```
  qcl-Type
typeB, typeC, typeD},
  ...
}
```

In the third embodiment, a method for defining the UE's QCL in the case of an inactive time and an active time, respectively, when separately operating with regard to the inactive time and the active time according to the gNB's cell DTX operation, will be described. Similarly to the situation of the power control operation in the second embodiment, if the inactive time lasts for a considerable period of time during the cell DTX operation, or if the cell DTX cycle value is configured long such that the inactive time occupies a relatively large proportion in the entire cell DTX cycle, the gNB loses an opportunity to update the QCL configuration for the UE during the inactive time according to the cell DTX operation, and the accuracy of QCL determination by the UE may deteriorate. In the third embodiment, the UE's QCL determination method regarding the following channels or signals in the inactive time interval of the cell DTX operation will be described:
PDCCH DMRS;
PDSCH DMRS; and/or
CSI-RS.

Method 1: the UE determines that at least one of the PDCCH DMRS, PDSCH DMRS, and CSI-RS is QCLed with an SSB. That is, a reference RS for QCL determination of the signals during the inactive time of cell DTX may be defined as an SSB. This is based on an assumption that, even during the inactive time of cell DTX, the gNB's SSB transmission is maintained, or minimum SSB transmission which may serve as a basis for QCL determination is guaranteed.

Method 2: the UE determines that at least one of the PDSCH DMRS and CSI-RS is QCLed with the PDCCH DMRS of the latest PDCCH search space monitored by the UE. If there are multiple PDCCH DMRSs, the UE determines that the PDCCH DMRS in a specific CORESET is a reference RS for QCL determination. For example, the UE determines that the PDCCH DMRS in a CORESET corresponding to a CORESET identifier having the smallest value is a reference RS. As a modified example of method 2, the UE may determine that at least one of the PDSCH DMRS and CSI-RS is QCLed with the PDCCH DMRS of the latest PDCCH search space monitored by the UE during the active time.

Method 3: the UE determines that at least one of the PDSCH DMRS and CSI-RS is QCLed with a downlink signal included in the latest slot monitored by the UE. The downlink signal may be a PDCCH DMRS or a CSI-RS. If the latest slot includes both a PDCCH DMRS and a CSI-RS, the gNB may inform the UE of which signal is to be used as a reference RS for QCL determination through higher layer signaling, for example.

At least one of above method 1, 2, or 3 may be applied during an inactive time during a cell DTX operation. During an active time, or in a case other than the cell DTX operation, the reference RS for the UE's QCL determination may be determined according to an existing method.

The third embodiment may be modified variously. For example, the same may be likewise applied to a gNB energy saving operation in which the gNB's antennas or PAs are adjusted, as described above. Operations of the gNB and the UE during the active time described above may be applied to a gNB normal mode, and operations of the gNB and the UE during the inactive time described above may be applied to a gNB energy saving mode.

### Fourth Embodiment

In the fourth embodiment, an example of a UE procedure and a gNB procedure according to an exemplary embodiment of the disclosure will be described. The UE procedure and gNB procedure in the fourth embodiment may be combined with at least one of the first to third embodiments and performed.

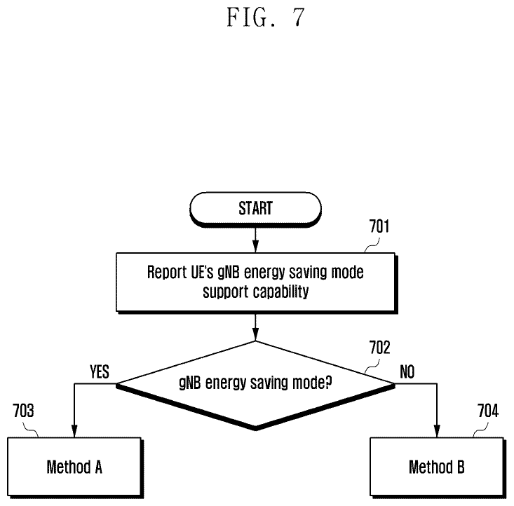

FIG. 7 illustrates an example of a UE procedure according to an embodiment of the disclosure. Specifically, FIG. 7 is a flowchart regarding a procedure the UE controls uplink transmission power or determines downlink QCL according to whether the gNB is in a gNB energy saving mode or not.

Referring to FIG. 7, in step 701, the UE reports UE capability information including gNB energy saving mode support capability to the gNB. Specifically, the UE capability information may include at least one piece of information from among capability information related to a gNB energy saving mode, such as information indicating whether the UE supports a gNB energy saving mode or not, control information regarding the frequency band supported by the UE, and control information regarding the channel bandwidth supported by the UE.

Thereafter, in step 702, the UE determines whether the gNB operates in the gNB energy saving mode or not. The gNB may inform the UE of whether the gNB operates in a gNB energy saving mode or in a gNB normal mode, through signaling. If the gNB operates in the gNB energy saving mode, or in the case of an inactive time interval of a cell DTX operation, the UE performs uplink transmission power adjustment according to the first embodiment and/or second embodiment described above. In addition, the UE may follow the method of the third embodiment described above, in order to determine downlink QCL (703, method A). The UE may perform uplink transmission, based on uplink transmission power determined according to the first embodiment and/or second embodiment, or may perform up/downlink channel/signal transmission/reception, based on downlink QCL determined according to the third embodiment.

If the gNB operates in the gNB normal mode, or in the case of an active time interval of a cell DTX operation, the UE adjusts uplink transmission power according to the existing method, or determines downlink QCL (704, method B). The UE may perform uplink transmission, based on uplink transmission power determined according to the existing method, or may perform up/downlink channel/signal transmission/reception, based on downlink QCL determined according to the existing method.

It is also possible to perform the disclosure after omitting steps described with reference to FIG. 7, changing the order thereof, or adding steps not described.

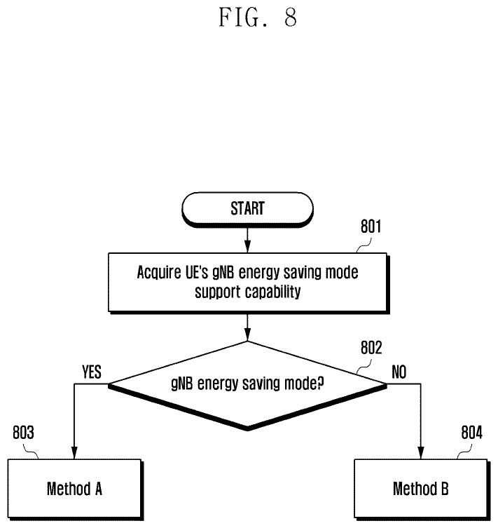

FIG. 8 illustrates an example of a gNB procedure according to an embodiment of the disclosure.

Referring to FIG. 8, in step 801, the gNB acquired UE capability information including gNB energy saving mode support capability from the UE. Specifically, the UE capability information may include at least one piece of information from among capability information related to a gNB energy saving mode, such as information indicating whether the UE supports a gNB energy saving mode or not, control information regarding the frequency band supported by the UE, and control information regarding the channel bandwidth supported by the UE.

Thereafter, in step 802, the gNB may determine, based on the UE capability, whether to operate in a gNB energy saving mode or in a gNB normal mode, and may inform the UE thereof through signaling. Information which may be included as the gNB mode is changed may be preconfigured for the UE by the gNB through signaling.

In step 803, the gNB recognizes that the UE has adjusted uplink transmission power or determined downlink QCL so as to correspond to the inactive time or gNB energy saving mode according to the above-described embodiment (method A), and considers uplink transmission power and downlink QCL in the following scheduling step. As an example, the gNB may perform downlink channel/signal transmission in consideration of downlink QCL determined by the UE according to the third embodiment.

In step 804, the gNB recognizes that the UE has adjusted uplink transmission power or determined downlink QCL so as to correspond to the active time or gNB normal mode according to the above-described embodiment (method B), and considers uplink transmission power and downlink QCL in the following scheduling step. As an example, the gNB may perform downlink channel/signal transmission in consideration of downlink QCL determined by the UE according to the existing method.

It is also possible to perform the disclosure after omitting steps described with reference to FIG. 8, changing the order thereof, or adding steps not described.

Within the cell controlled by the gNB operating as described above, a UE supporting a UE operation according to the gNB energy saving mode (hereinafter, referred to as UE A) and a UE not supporting the same (hereinafter, referred to as UE B) may coexist. UE A may perform UE operations according to the above-described specific embodiments. UE B cannot respond to a change in the gNB transmission scheme according to the gNB energy saving mode, and thus has a concern of performance degradation in connection with the transmission efficiency, cell capacity, throughput, and UE power consumption. Therefore, if the gNB can distinguish between UE A and UE B with reference to a UE capability report from the UE, an additional operation may be taken to prevent performance degradation of UE B. For example, the gNB may hand over UE B to an adjacent cell having a gNB in a gNB normal mode state, instead of the current cell which is supposed to switch to a gNB energy saving mode.

The fourth embodiment may be variously modified. For example, the step in which the UE reports UE capability to the gNB may be omitted. The gNB energy saving mode of the fourth embodiment may include not only a cell DTX or cell DRX operation, but also a gNB antenna or PA changing operation.

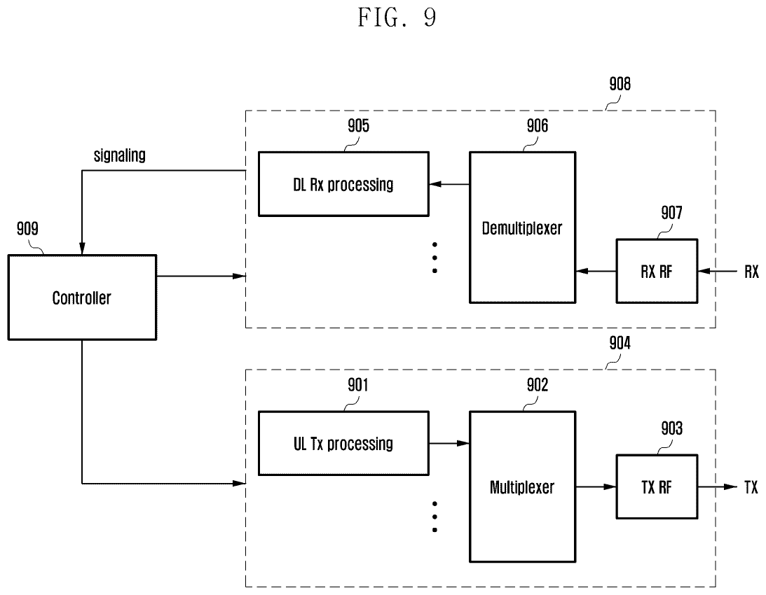

FIG. 9 illustrates a UE transmission/reception device in a wireless communication system according to an embodiment of the disclosure. For convenience of description, illustration and description of devices having no direct relevance to the disclosure may be omitted.

Referring to FIG. 9, the UE may include a transmitter 904 including an uplink transmission processing block 901, a multiplexer 902, and a transmission RF block 903, a receiver 908 including a downlink reception processing block 905, a demultiplexer 906, and a reception RF block 907, and a controller 909. The controller 909 may control respective constituent blocks of the receiver 908 for receiving data channels or control channels transmitted by the gNB as described above, and respective constituent blocks of the transmitter 904 for transmitting uplink signals.

The transmission processing block 901 of the transmitter 904 of the UE may generate signals to be transmitted by performing processes such as channel coding and modulation. A signal generated by the transmission processing block 901 may be multiplexed with another uplink signal by the multiplexer 902, may undergo signal processing in the transmission RF block 903, and may then be transmitted to the gNB.

The receiver 908 of the UE demultiplexes signals received from the gNB and distributes the same to respective downlink reception processing blocks. The downlink reception processing block 905 may acquire control information or data transmitted by the gNB by performing processes such as demodulation and channel decoding with regard to downlink signals from the gNB. The receiver 908 of the UE may apply the result of output form the downlink reception processing block to the controller 909, thereby supporting operations of the controller 909.

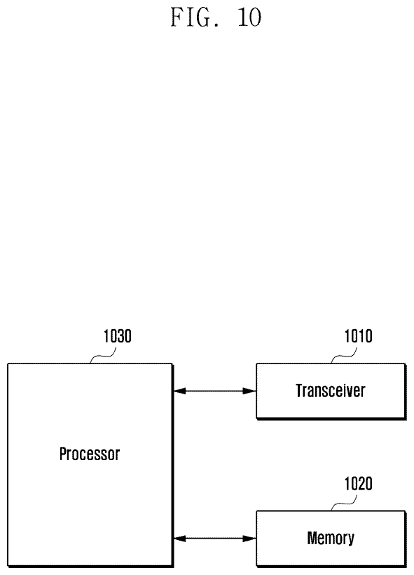

FIG. 10 illustrates a structure of a UE according to an embodiment of the disclosure.

Referring to FIG. 10, a UE of the disclosure may include a processor 1030, a transceiver 1010, and a memory 1020. However, components of the UE are not limited to the above-described example. For example, the UE may include a larger or smaller number of components than the above-described components. In addition, the processor 1030, the transceiver 1010, and the memory 1020 may be implemented in the form of a single chip. According to an embodiment, the transceiver 1010 of FIG. 10 may include the transmitter 904 and the receiver 908 of FIG. 9. Also, the processor 1030 of FIG. 9 may include the controller 909 of FIG. 9.

According to an embodiment, the processor 1030 may control a series of processes such that the UE can operate according to the above-described embodiments of the disclosure. For example, according to an embodiment of the disclosure, the processor 1030 may control the components of the UE to perform methods for regulating uplink transmission power of the UE or determining the QCL of a downlink signal. The processor 1030 may include one or multiple processors, and the processor 1030 may execute programs stored in the memory 1020 to perform transmission and reception operations of the UE in a wireless communication system employing the above-described operations of the disclosure.

The transceiver 1010 may transmit/receive signals with the base station. The signals transmitted/received with the base station may include control information and data. The transceiver 1010 may include an RF transmitter configured to up-convert and amplify the frequency of transmitted signals, an RF receiver configured to low-noise-amplify received signals and down-convert the frequency thereof, and the like. However, this is only an embodiment of the transceiver 1010, and the components of the transceiver 1010 are not limited to the RF transmitter and the RF receiver. In addition, the transceiver 1010 may receive signals through a radio channel, output the same to the processor 1030, and transmit signals output from the processor 1030 through the radio channel.

According to an embodiment, the memory 1020 may store programs and data necessary for operations of the UE. In addition, the memory 1020 may store control information or data included in signals transmitted/received by the UE. The memory 1020 may include storage media such as a ROM, a RAM, a hard disk, a CD-ROM, and a DVD, or a combination of storage media. Also, the memory 1020 may include multiple memories. According to an embodiment, the memory 1020 may store programs for performing method for regulating uplink transmission power of the UE or determining the QCL of a downlink signal.

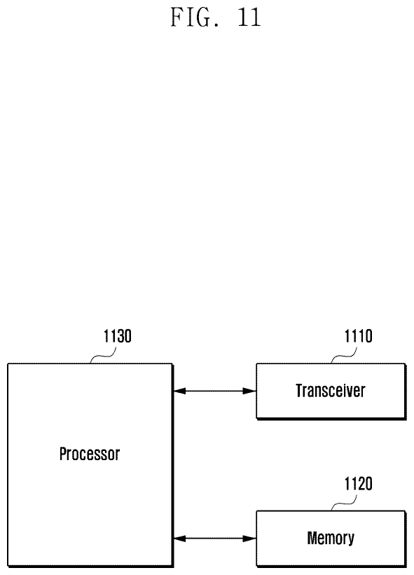

FIG. 11 illustrates a structure of a base station according to an embodiment of the disclosure.

Referring to FIG. 11, a base station of the disclosure may include a processor 1130, a transceiver 1110, and a memory 1120. However, components of the base station are not limited to the above-described example. For example, the base station may include a larger or smaller number of components than the above-described components. In addition, the processor 1130, the transceiver 1110, and the memory 1120 may be implemented in the form of a single chip.

The processor 1130 may control a series of processes such that the base station can operate according to the above-described embodiments of the disclosure. For example, according to an embodiment of the disclosure, the processor 1130 may control the components of the base station to perform method for scheduling the UE according to regulation of uplink transmission power of the UE or determination of the QCL of a downlink signal. The processor 1130 may include one or multiple processors, and the processor 1130 may execute programs stored in the memory 1120 to perform methods for scheduling the UE according to the above-described channel state measurement reporting request for the UE of the disclosure.

The transceiver 1110 may transmit/receive signals with the UE. The signals transmitted/received with the UE may include control information and data. The transceiver 1110 may include an RF transmitter configured to up-convert and amplify the frequency of transmitted signals, an RF receiver configured to low-noise-amplify received signals and down-convert the frequency thereof, and the like. However, this is only an embodiment of the transceiver 1110, and the components of the transceiver 1110 are not limited to the RF transmitter and the RF receiver. In addition, the transceiver 1110 may receive signals through a radio channel, output the same to the processor 1130, and transmit signals output from the processor 1130 through the radio channel.

According to an embodiment, the memory 1120 may store programs and data necessary for operations of the base station. In addition, the memory 1120 may store control information or data included in signals transmitted/received by the base station. The memory 1120 may include storage media such as a ROM, a RAM, a hard disk, a CD-ROM, and a DVD, or a combination of storage media. In addition, the memory 1120 may include multiple memories. According to an embodiment, the memory 1120 may store programs for performing methods for scheduling the UE according to regulation of uplink transmission power of the UE or determination of the QCL of a downlink signal

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. Although particular terms are used, they have been used in a general sense merely to easily explain the technical contents of the disclosure and help understanding of the disclosure, and are not intended to limit the scope of the disclosure. Furthermore, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. In addition, the embodiments of the disclosure may be applied to other communication systems and other variants based on the technical idea of the embodiments may also be implemented.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, configuration information on a network energy saving mode;
identifying that the network energy saving mode is applied;
identifying an uplink transmission power for transmitting an uplink signal on an uplink channel in the network energy saving mode or a quasi co-location (QCL) relation of at least one of downlink signal or a downlink channel based on a reference signal in the network energy saving mode; and
transmitting, to the base station, the uplink signal on the uplink channel based on the uplink transmission power or receiving, from the base station, the at least one of a downlink signal or a downlink channel based on the QCL relation.

2. The method of claim 1, wherein the uplink transmission power is identified based on a pathloss identified based on a pathloss reference signal for the network energy saving mode, and
wherein the pathloss reference signal for the network energy saving mode is included in a set of pathloss reference signals for a normal mode.

3. The method of claim 2, wherein the pathloss reference signal for the network energy saving mode corresponds to a synchronization signal block (SSB).

4. The method of claim 1, wherein the uplink transmission power is identified based on a power control adjustment state for the network energy saving mode, and
wherein a value of the power control adjustment state is set to 0 in case that an inactive time in the network energy saving mode is longer than a threshold.

5. The method of claim 1, further comprising:
transmitting, to the base station, capability information including information associated with a support of the network energy saving mode.

6. The method of claim 1, wherein the network energy saving mode corresponds to at least one of a cell discontinuous transmission (DTX), a cell discontinuous reception (DRX), or an adjustment of a network operation for antennas or power amplifiers.

7. A method performed by a base station in a communication system, the method comprising:
transmitting, to a terminal, configuration information on a network energy saving mode;
identifying that the network energy saving mode is applied; and
receiving, from the terminal, an uplink signal on an uplink channel or transmitting, to the terminal, at least one of a downlink signal or a downlink channel using a quasi co-location (QCL) relation based on a reference signal in the network energy saving mode,
wherein an uplink transmission power for the uplink channel corresponds to the uplink transmission power in the network energy saving mode.

8. The method of claim 7, wherein the uplink transmission power is associated with a pathloss identified based on a pathloss reference signal for the network energy saving mode, and
wherein the pathloss reference signal for the network energy saving mode is included in a set of pathloss reference signals for a normal mode.

9. The method of claim 8, wherein the pathloss reference signal for the network energy saving mode corresponds to a synchronization signal block (SSB).

10. The method of claim 7, wherein the uplink transmission power is based on a power control adjustment state for the network energy saving mode, and
wherein a value of the power control adjustment state is set to 0 in case that an inactive time in the network energy saving mode is longer than a threshold.

11. The method of claim 7, further comprising:
receiving, from the terminal, capability information including information associated with a support of the network energy saving mode.

12. The method of claim 7, wherein the network energy saving mode corresponds to at least one of a cell discontinuous transmission (DTX), a cell discontinuous reception (DRX), or an adjustment of a network operation for antennas or power amplifiers.

13. A terminal in a communication system, the terminal comprising:
a transceiver; and
a controller operably coupled to the transceiver, the controller configured to:
receive, from a base station, configuration information on a network energy saving mode, identify that the network energy saving mode is applied,
identify an uplink transmission power for transmitting an uplink signal on an uplink channel in the network energy saving mode or a quasi co-location (QCL) relation of at least one of downlink signal or a downlink channel based on a reference signal in the network energy saving mode, and
transmit, to the base station, the uplink signal on the uplink channel based on the uplink transmission power or receive, from the base station, the at least one of a downlink signal or a downlink channel based on the QCL relation.

14. The terminal of claim 13, wherein the uplink transmission power is identified based on a pathloss identified based on a pathloss reference signal for the network energy saving mode, and
wherein the pathloss reference signal for the network energy saving mode is included in a set of pathloss reference signals for a normal mode.

15. The terminal of claim 14, wherein the pathloss reference signal for the network energy saving mode corresponds to a synchronization signal block (SSB).

16. The terminal of claim 13, wherein the uplink transmission power is identified based on a power control adjustment state for the network energy saving mode, and
wherein a value of the power control adjustment state is set to 0 in case that an inactive time in the network energy saving mode is longer than a threshold.

17. The terminal of claim 14, wherein the controller is further configured to transmit, to the base station, capability information including information associated with a support of the network energy saving mode.

18. The terminal of claim 13, wherein the network energy saving mode corresponds to at least one of a cell discontinuous transmission (DTX), a cell discontinuous reception (DRX), or an adjustment of a network operation for antennas or power amplifiers.

19. A base station in a communication system, the base station comprising:
a transceiver; and
a controller operably coupled to the transceiver, the controller configured to:
transmit, to a terminal, configuration information on a network energy saving mode, identify that the network energy saving mode is applied, and
receive, from the terminal, an uplink signal on an uplink channel or transmit, to the terminal, at least one of a downlink signal or a downlink channel using a quasi co-location (QCL) relation based on a reference signal in the network energy saving mode,
wherein an uplink transmission power for the uplink channel corresponds to the uplink transmission power in the network energy saving mode.

20. The base station of claim 19, wherein the uplink transmission power is associated with a pathloss identified based on a pathloss reference signal for the network energy saving mode, and
wherein the pathloss reference signal for the network energy saving mode is included in a set of pathloss reference signals for a normal mode.

21. The base station of claim 20, wherein the pathloss reference signal for the network energy saving mode corresponds to a synchronization signal block (SSB).

22. The base station of claim 19, wherein the uplink transmission power is based on a power control adjustment state for the network energy saving mode, and
wherein a value of the power control adjustment state is set to 0 in case that an inactive time in the network energy saving mode is longer than a threshold.

23. The base station of claim 19, wherein the controller is further configured to receive, from the terminal, capability information including information associated with a support of the network energy saving mode.

24. The base station of claim 19, wherein the network energy saving mode corresponds to at least one of a cell discontinuous transmission (DTX), a cell discontinuous reception (DRX), or an adjustment of a network operation for antennas or power amplifiers.
